(19) United States
(12) Patent Application Publication
(10) Pub. No.: US 2012/0039311 A1
(43) Pub. Date: Feb. 16, 2012

(54) VOICE CALL DETECTION

(75) Inventors: Samir M. Hodroj, Bellevue, WA (US); Omar A. Hassan, Bellevue, WA (US)

(73) Assignee: T-Mobile USA, Inc., Bellevue, WA (US)

(21) Appl. No.: 12/856,518

(22) Filed: Aug. 13, 2010

(51) Int. Cl. H04W 4/00; H04L 12/66

(52) U.S. Cl. 370/338; 370/352

(57) ABSTRACT

Systems and methods for detecting a voice call are described. In one aspect, a data stream is identified and analyzed to determine whether the data stream is associated with a single device. The data stream is further analyzed to determine whether it is actively communicating data packets and to identify a data packet size. Bandwidth for the data stream is reserved if the data stream is associated with a single device, is actively sending data packets, and the data packet size is smaller than a threshold value.

### BACKGROUND

Many types of devices and systems communicate data between one another via one or more communication links. These communication links typically have a limited bandwidth available to communicate data and other information. When multiple devices (or multiple data streams) share a common communication link, the bandwidth associated with that link is allocated among the multiple devices (or multiple data streams). In some situations, this allocation of bandwidth may result in delayed communication of certain data. To allocate bandwidth among different data streams, it is often desirable to determine the type of data associated with the various data streams.

When allocating bandwidth among multiple devices, or multiple data streams, certain devices or types of data may be given priority over other devices or data types. For example, time-critical data associated with a live-streamed event may be given priority over other types of data that are not time-critical, such as email messages. Therefore, in situations where bandwidth is shared among multiple devices or multiple data streams, it is desirable to detect certain types of data to be treated as high priority data.

### BRIEF DESCRIPTION OF THE DRAWINGS

In the Figures, the left-most digit of a component reference number identifies the particular Figure in which the component first appears.

FIG. 1 shows an exemplary environment capable of implementing the systems and methods described herein, according to one embodiment.

FIG. 2 is a block diagram showing various components of an exemplary data communication gateway, according to one embodiment.

FIG. 3 shows an exemplary procedure for detecting the start of a voice call, according to one embodiment.

FIG. 4 shows an exemplary procedure for detecting the end of a voice call, according to one embodiment.

FIG. 5 shows an exemplary procedure for assigning a data handling priority to received data, according to one embodiment.

FIG. 6 shows an exemplary procedure for determining a data handling priority to assign to received data, according to one embodiment.

FIG. 7 is a block diagram showing an exemplary local device, according to one embodiment.

### DETAILED DESCRIPTION

### Overview

The systems and methods described herein relate to detecting the start and end of a voice call over a communication link, such as a WiFi link. These systems and methods reserve bandwidth for voice call data, and assign voice call data a higher priority than other types of non-voice call data. When the end of a voice call is detected, the previously reserved bandwidth is released and reallocated for other purposes.

Although particular examples discussed herein relate to a data communication gateway, the present invention is applicable to any type of data communication device. Specific examples also discuss the use of WiFi and Unlicensed Mobile Access data, but alternative embodiments may use other communication protocols and data transmission formats. The specific devices and communication links discussed herein are provided for purposes of discussion and to provide an exemplary implementation of the invention. The present invention is applicable to any type of data received from any type of device in any operating environment.

### An Exemplary System for Voice Call Detection

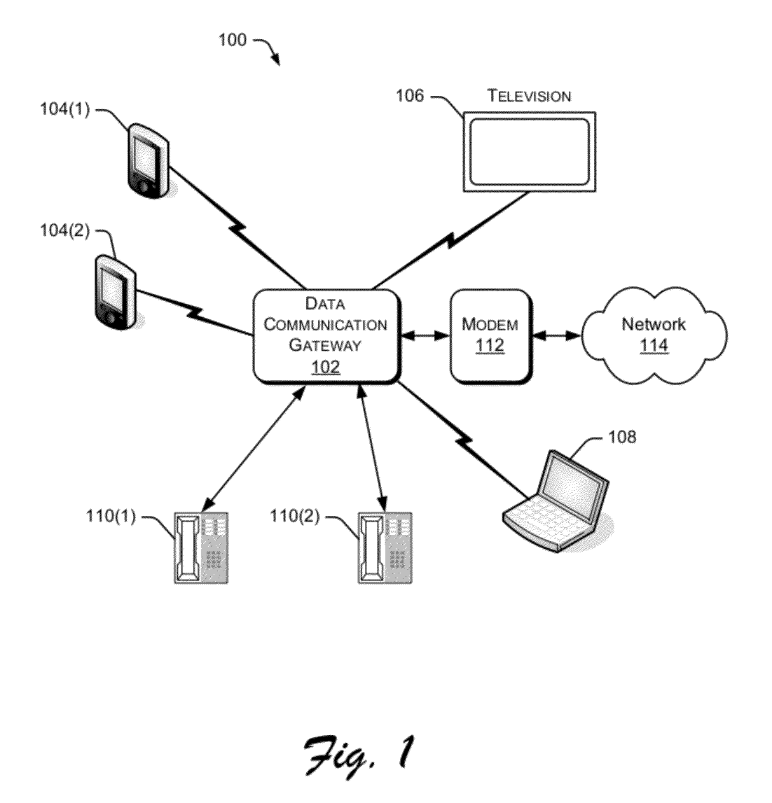

FIG. 1 shows an exemplary environment 100 capable of implementing the systems and methods described herein, according to one embodiment. Environment 100 includes a data communication gateway 102 that operates as a central hub for voice, data services and messaging communication between multiple devices. Data communication gateway 102 includes router functionality for communicating data between various networks and devices. Data communication gateway 102 further includes WiFi functionality for sending and receiving data using a WiFi network.

As shown in FIG. 1, data communication gateway 102 is coupled to two portable phones 104(1) and 104(2), a television 106, a computer 108 and two telephones 110(1) and 110(2). In alternate environments, any type of device can be coupled to data communication gateway 102, such as tablet computers, game consoles, portable entertainment systems, and so forth. In one embodiment, portable phones 104(1) and 104(2) are DECT (Digital Enhanced Cordless Telecommunications) phones, which are cordless phones that can be used in a local environment. DECT phones typically communicate with a base station, which is connected to a phone line or data communication network. In the embodiment of FIG. 1, the base station functionality is contained within data communication gateway 102, thereby eliminating the need for a separate base station. Although two portable phones 104(1) and 104(2) are shown in FIG. 1, particular implementations of data communication gateway 102 can support any number of portable phones.

In an alternate embodiment, phones 104(1) and 104(2) communicate with data communication gateway 102 via a WiFi communication link. In this embodiment, the data communicated between phones 104(1), 104(2) and data communication gateway 102 may be native UMA (Unlicensed Mobile Access) voice data.

Television 106 displays various data received from data communication gateway 102, such as program information, video content, audio content, web site content, and so forth. In the embodiment of FIG. 1, television 106 communicates with data communication gateway 102 via a WiFi communication link using the DLNA (Digital Living Network Alliance) specification. Through the communication link with data communication gateway 102, television 106 is capable of communicating with Internet-based web servers to retrieve content and interact with those servers.

Computer 108 is shown in FIG. 1 as a laptop or netbook style of computing device. Alternate embodiments may include any type of computing device, such as a desktop computer, a tablet, a handheld computer, a set top box, a game console, and the like. Computer 108 communicates with data communication gateway 102 via a WiFi communication link or other wireless communication system. In alternate embodiments, computer 108 may communicate with data communication gateway 102 via a wired communication link using any data communication protocol.

Telephones 110(1) and 110(2) are traditional telephones that are coupled to data communication gateway 102 via a traditional telephone cable. In a particular implementation, data communication gateway 102 includes support for two telephones. Alternate embodiments of data communication gateway 102 include support for any number of telephones. In one implementation, voice data associated with telephones 110(1) and 110(2) is communicated to other telephones via the Internet or other data communication network.

Data communication gateway 102 is also coupled to a modem 112, which is coupled a data communication network 114, such as the Internet. Modem 112 communicates with a variety of web servers and other resources accessible via data communication network 114. Data communication network 114 may include any number of data communication networks, such as local area networks (LANs), wide area networks (WANs), and the like.

As used herein, the term “local device” collectively refers to phones 104(1) and 104(2), television 106, computer 108 and telephones 110(1) and 110(2). These devices are generally referred to as “local devices” due to their proximate location to data communication gateway 102 and their ability to communicate with the gateway.

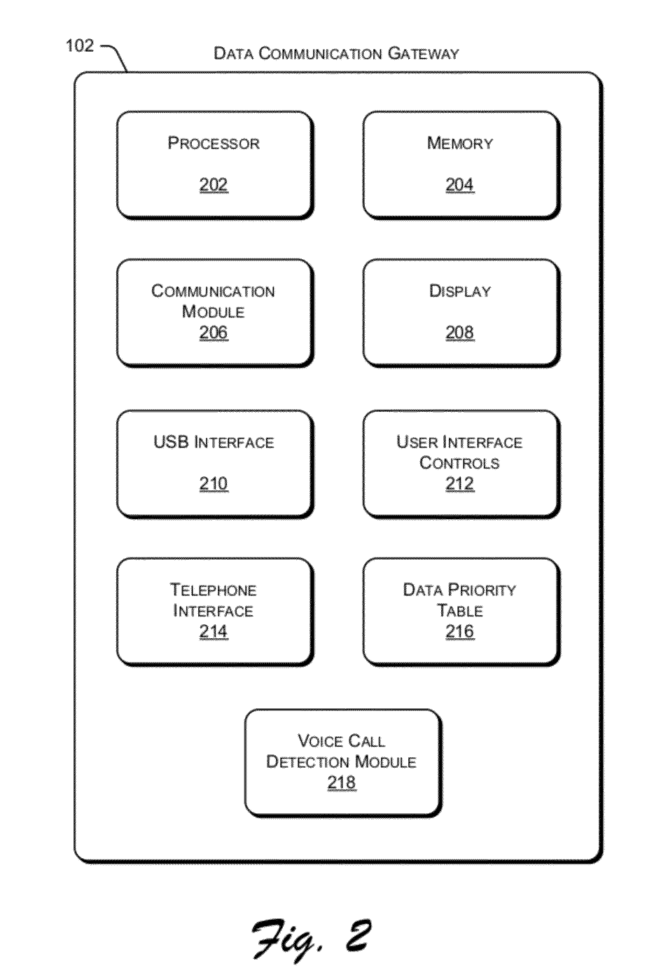

FIG. 2 is a block diagram showing various components of an exemplary data communication gateway, according to one embodiment. Data communication gateway 102 includes a processor 202, a memory 204, and a communication module 206. Processor 202 executes various instructions to implement the functions described herein. Memory 204 stores the instructions and other data used by processor 202 and other modules contained in data communication gateway 102. Communication module 206 allows data communication gateway 102 to communicate with other devices and systems, such as the systems and devices shown in FIG. 1. Additionally, communication module 206 allows data communication gateway 102 to communicate with devices and systems via data communication network 114 shown in FIG. 1. In a particular embodiment, communication module 206 includes a WiFi communication interface, DECT communication interface, and various other data communication interfaces and protocols.

Data communication gateway 102 also includes a display 208, a USB (Universal Serial Bus) interface 210 and user interface controls 212. Display 208 presents information to a user of data communication gateway 102, such as operating information, configuration settings and menu navigation information. USB interface 210 allows data communication gateway 102 to communicate with other devices using a USB port. A particular implementation of data communication gateway 102 includes two USB ports. User interface controls 212 include buttons, LEDs (light-emitting diodes) and the like to receive instructions from a user of data communication gateway 102 and to communicate information to the user in combination with display 208, as discussed above.

Data communication gateway 102 also includes a telephone interface 214 for communicating with one or more conventional telephones, such as telephones 110(1) and 110(2) shown in FIG. 1. Data received via telephone interface 214 is communicated to other devices or systems connected directly to data communication gateway 102 or coupled to the gateway via data communication network 114. Data communication gateway 102 further includes a data priority table 216 that contains information used to prioritize data communications. Data priority table 216 assigns various data throughput handling priorities based on the source of the received data, the type of received data and the manufacturer of the device communicating the received data. Additional details regarding the application of the information in data priority table 216 are discussed herein.

Additionally, data communication gateway 102 includes a voice call detection module 218, which detects the start of a voice call and detects the end of a voice call. The procedures for detecting the start and end of a voice call are discussed below.

### An Exemplary Procedure for Voice Call Detection

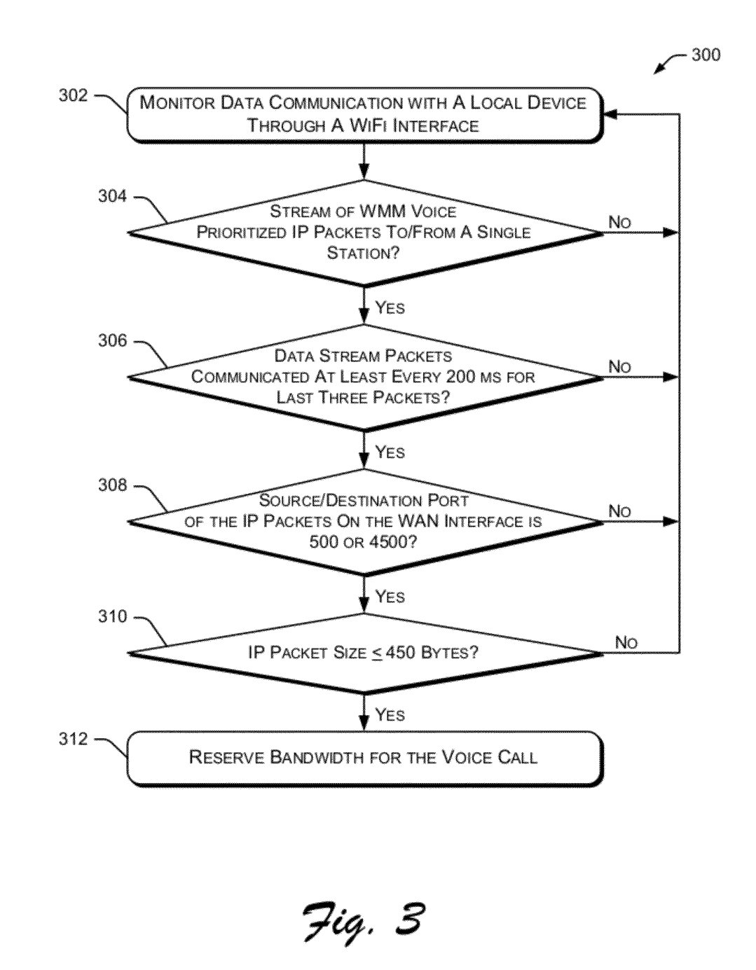

FIG. 3 shows an exemplary procedure 300 for detecting the start of a voice call, according to one embodiment. In a particular implementation, procedure 300 is performed by a data communication gateway of the type discussed herein. Initially, the procedure monitors data communication with a local device through a WiFi interface in the data communication gateway (block 302). When monitoring the data stream, the procedure analyzes various traffic patterns and traffic conditions to determine whether the data stream indicates the start of a voice call, such as UMA voice data.

Procedure 300 monitors the data stream and watches for WMM (WiFi MultiMedia) voice prioritized IP packets communicated to or from a single local device that was not previously engaged in a voice call (block 304). If the procedure does not detect this type of packet, the procedure continues monitoring the data stream at block 302. If WMM voice prioritized IP packets are detected, procedure 300 determines whether the data stream is actively communicating data packets at least every 200 ms (milliseconds) for at least the last three consecutive packets (block 306). If not, the procedure returns to block 302 to continue monitoring the data stream.

If the data stream is actively communicating data packets at least every 200 ms for the last three consecutive packets, procedure 300 continues to block 308 to determine whether the source or destination port of the data packets on a WAN interface is 500 or 4500 (i.e., associated with an IPSEC port). If the port is not 500 or 4500, the procedure returns to block 302 to continue monitoring the data stream. If the source or destination port is 500 or 4500, the procedure determines whether the sizes of the data packets on the WAN interface are each less than or equal to 450 bytes (block 310). If not, procedure 300 returns to block 302 to continue monitoring the data stream.

If the data packets are less than or equal to 450 bytes, the data stream has met the traffic patterns and traffic conditions indicating the start of a voice call. The procedure then reserves bandwidth for the voice call (block 312) to ensure a quality of service for the voice call data. Additional details regarding the prioritization of voice call data and allocation of bandwidth among data streams are discussed herein.

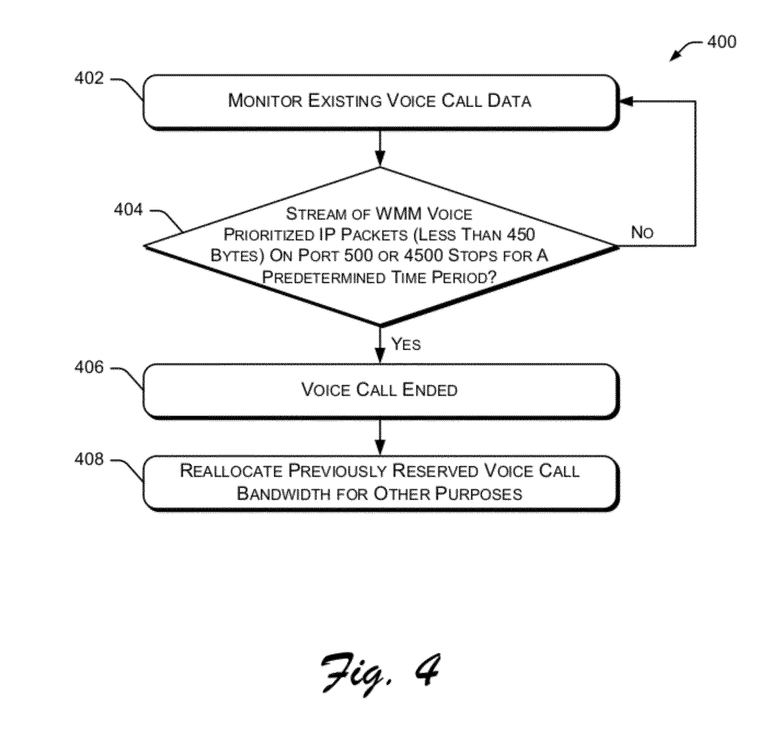

FIG. 4 shows an exemplary procedure 400 for detecting the end of a voice call, according to one embodiment. In a particular implementation, procedure 400 is performed by a data communication gateway of the type discussed herein. After a voice call has been detected as discussed above with respect to FIG. 3, the procedure monitors the existing call data (block 402) to detect the end of the voice call. The data stream being monitored includes WMM voice prioritized IP packets. The procedure monitors this data stream to detect the stoppage of the data stream (block 404). The data stream is considered to have stopped when the voice call no longer sends the WMM packets on source port 500 or 4500 for a predetermined time period, such as five seconds. If the voice call is still active, the procedure returns to block 402 to continue monitoring the existing voice call data.

If the voice call has ended, procedure 400 generates a signal indicating that the voice call ended (block 406) and reallocates previously reserved bandwidth for other purposes (block 408). Since the voice call has ended, the previously reserved bandwidth is not longer necessary for the voice call. This bandwidth can be reallocated to other voice calls or other data streams that are currently active.

In a particular embodiment, a rate limiting function is applied when at least one voice call is active. The rate limiting function is based on the number of active voice call sessions using the same bandwidth and other criteria. The rate limiting function limits non-voice traffic to ensure sufficient bandwidth for the voice traffic data. For example, voice calls associated with a preferred service provider are allocated a particular bandwidth, such as 60K bps (bits per second) for each session. Any remaining bandwidth is allocated to non-voice traffic and voice calls associated with non-preferred service providers. When a voice call session is terminated, the bandwidth allocated to that session is made available to other traffic.

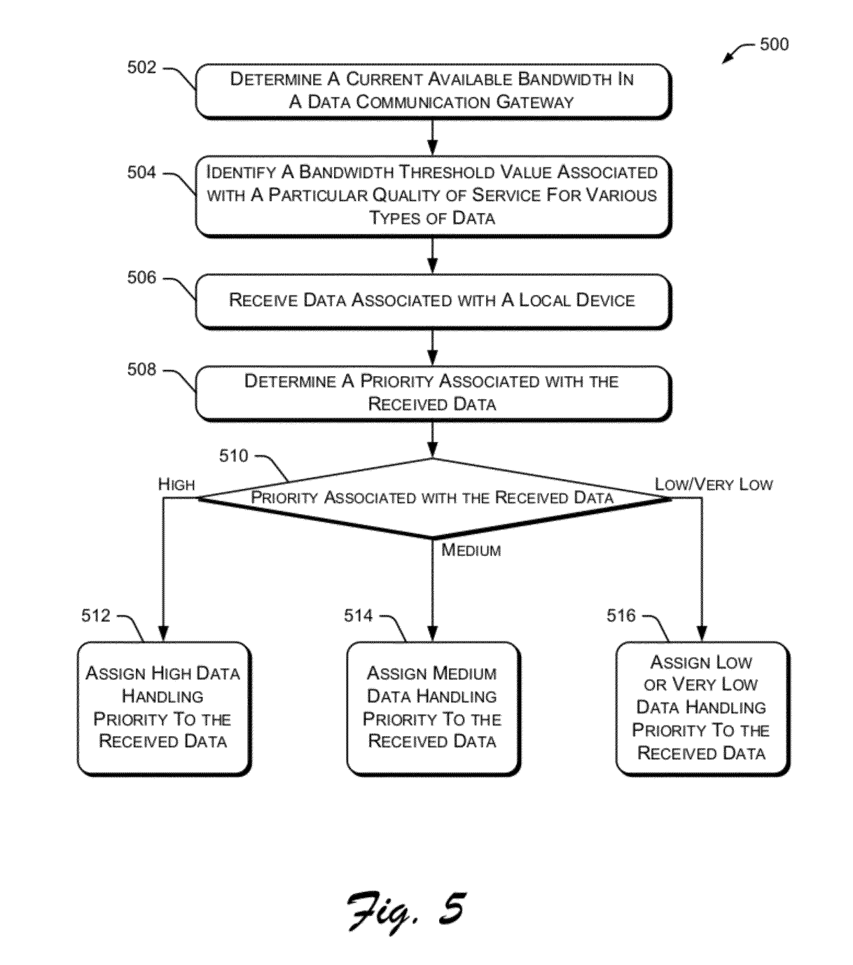

FIG. 5 shows an exemplary procedure 500 for assigning a data handling priority to received data, according to one embodiment. In a particular implementation, procedure 500 is performed by a data communication gateway of the type discussed herein. Initially, procedure 500 determines a current available bandwidth in a data communication gateway (block 502). This available bandwidth may be shared by multiple devices and/or multiple data streams. For example, the available bandwidth may be shared by live voice data, data services and messaging communications. Certain types of data, such as live voice data, may require a minimum bandwidth to ensure a particular quality of service (e.g., intelligible voice transmission) for that type of data. Thus, procedure 500 continues by identifying a bandwidth threshold value associated with a particular quality of service for various types of data supported by the system (block 504). Certain types of data, such as live voice data, may have a bandwidth threshold value (e.g., minimum bandwidth needed to ensure acceptable voice quality) while other types of data may not have a bandwidth threshold value.

The procedure of FIG. 5 continues by receiving data associated with a local device (block 506). As mentioned above, a local device is any device coupled to data communication gateway 102 shown in FIG. 1. Receiving data associated with a local device includes data received by the data communication gateway from the local device or data received by the data communication gateway for communication to the local device. In particular implementations, the received data is a request to establish a communication link between a local device and another system or device. Such request may be referred to as a “reservation request” or a “bandwidth reservation request”.

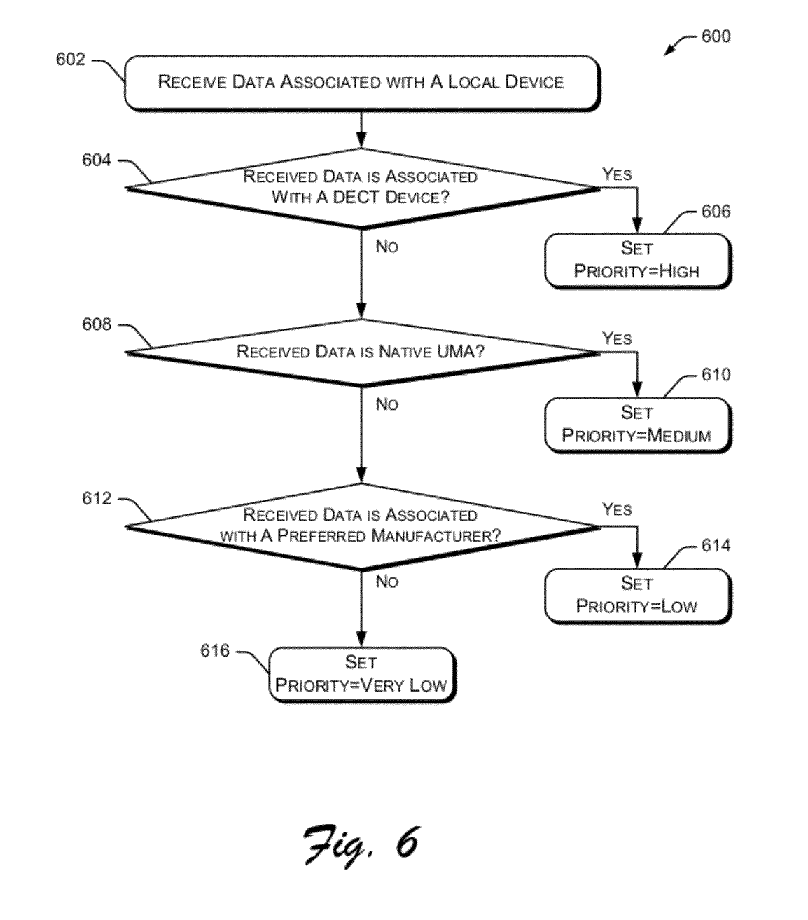

Procedure 500 then determines a priority associated with the received data (block 508). The procedure for determining this priority is discussed herein with respect to FIG. 6. Based on the priority associated with the received data (block 510), a data handling priority is assigned to the received data. In a particular embodiment, the assigned priority is “high”, “medium”, or “low” (blocks 512, 514 and 516, respectively). The data communication gateway uses the assigned priority to allocate available bandwidth to the received data as well as other data being handled by the data communication gateway.

FIG. 6 shows an exemplary procedure 600 for determining a data handling priority to assign to received data, according to one embodiment. In a particular implementation, procedure 600 is performed by a data communication gateway of the type discussed herein. Initially, procedure 600 receives data associated with a local device (block 602). The procedure then determines whether the received data is associated with a DECT (Digital Enhanced Cordless Telecommunications) device (block 604). This determination may include inspecting the type and size of data packet received as well as a destination port associated with the data. In other embodiments, the data may be tagged with metadata or other information that indicates the data type, data source, or data format. If the received data is associated with a DECT device, the data handling priority is set to “High” (block 606). DECT devices, such as DECT phones, are assigned the highest data handling priority to ensure that the live voice data associated with the DECT device is communicated in a manner that provides a clear understanding of the voice data to a user.

If the received data is not associated with a DECT device, procedure 600 determines whether the received data is native UMA (Unlicensed Mobile Access) voice data (block 608). If the received data is native UMA voice data, the data handling priority is set to “Medium” (block 610). The native UMA voice data is assigned a Medium priority to provide a good quality of data handling for the voice data. Thus, data associated with a DECT device is higher priority than native UMA voice data, but native UMA voice data has a higher priority than non-voice data discussed below.

If the received data is not associated with a DECT device and is not native UMA voice data, procedure 600 determines whether the received data is associated with a preferred manufacturer (or a preferred service provider) at block 612. If the data is associated with a preferred manufacturer or preferred service provider, the data handling priority is set to “Low” (block 614). If the data is not associated with a preferred manufacturer or preferred service provider, the data handling priority is set to “Very Low” (block 616). Thus, non-voice data associated with one or more preferred manufacturers or service providers may be given priority over non-voice data associated with other manufacturers or service providers. In alternate embodiments, all non-voice data is assigned a “Low” data handling priority, regardless of the manufacturer or service provider associated with the data.

Although the example of FIG. 6 assigns one of four different data handling priorities to specific data, alternate embodiments may use any number of data handling priorities associated with various types of data. In a particular embodiment, bandwidth is allocated to the different data handling priorities on a percentage basis. For example, if a DECT device has voice data to communicate and other devices are communicating non-voice data, the DECT device is allocated a percentage of bandwidth sufficient to communicate the voice data with the desired level of quality. The remaining bandwidth is allocated to the other devices communicating non-voice data. In this embodiment, if the available bandwidth is less than the minimum bandwidth required for the DECT device, the system will allocate 90% of the bandwidth to the DECT device and share the remaining 10% with the other devices.

The systems and method described herein are intended to give priority to voice data to ensure a good user experience when communicating voice data through the data communication gateway. This data priority is particularly important in situations where the available bandwidth is insufficient to handle all data simultaneously. For example, if one user is talking on a DECT phone or communicating on a UMA call, and another user is browsing the Internet using the same data communication gateway, the data associated with the DECT phone or UMA call is given priority over the Internet browser data. If there is sufficient bandwidth to handle all data streams simultaneously, then all users will have full access to the necessary bandwidth for their communications. However, if there is insufficient bandwidth to handle all data streams, the DECT phone data (or UMA call) is allocated a threshold bandwidth amount necessary to ensure a clear phone communication. In this situation, the Internet browser data is restricted to the remaining bandwidth.

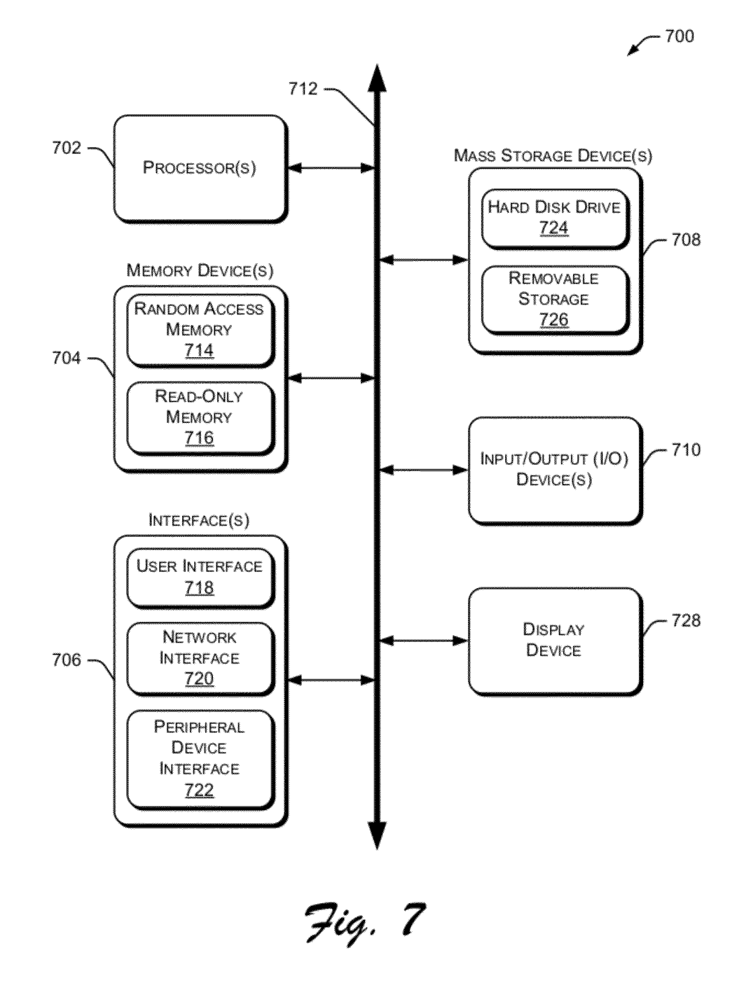

FIG. 7 is a block diagram showing an exemplary local device 700, according to one embodiment. Local device 700 may be used to perform various operations and functions, such as those discussed herein. Local device 700 can be any of a wide variety of devices, such as a portable phone, television, computing device, telephone, tablet, set top box, game system, and the like.

Local device 700 includes one or more processor(s) 702, one or more memory device(s) 704, one or more interface(s) 706, one or more mass storage device(s) 708, one or more Input/Output (I/O) device(s) 710, and a display device 728 all of which are coupled to a bus 712. Processor(s) 702 include one or more processors or controllers that execute instructions stored in memory device(s) 704 and/or mass storage device(s) 708. Processor(s) 702 may also include various types of processor-readable media, such as cache memory.

Memory device(s) 704 include various processor-readable media, such as volatile memory (e.g., random access memory (RAM)) 714 and/or nonvolatile memory (e.g., read-only memory (ROM) 716). Memory device(s) 704 may also include rewritable ROM, such as Flash memory.

Mass storage device(s) 708 include various processor-readable media, such as magnetic tapes, magnetic disks, optical disks, solid state memory (e.g., Flash memory), and so forth. As shown in FIG. 7, a particular mass storage device is a hard disk drive 724. Various drives may also be included in mass storage device(s) 708 to enable reading from and/or writing to the various processor-readable media. Mass storage device(s) 708 include removable storage 726 and/or non-removable media.

I/O device(s) 710 include various devices that allow data and/or other information to be input to or retrieved from local device 700. Example I/O device(s) 710 include cursor control devices, keyboards, keypads, microphones, monitors or other display devices, speakers, printers, network interface cards, modems, lenses, CCDs or other image capture devices, and the like.

Display device 728 includes any type of device capable of displaying information to one or more users of local device 700. Examples of display device 728 include a display screen, monitor, display terminal, video projection device, and the like.

Interface(s) 706 include various interfaces that allow local device 700 to interact with other systems, devices, or computing environments. Example interface(s) 706 include any number of different network interfaces 720, such as interfaces to local area networks (LANs), wide area networks (WANs), wireless networks, and the Internet. Other interfaces include user interface 718 and peripheral device interface 722.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of local device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### CONCLUSION

Although the systems and methods for voice call detection have been described in language specific to structural features and/or methodological operations or actions, it is understood that the implementations defined in the appended claims are not necessarily limited to the specific features or actions described. Rather, the specific features and operations of voice call detection are disclosed as exemplary forms of implementing the claimed subject matter.

1. A processor-implemented method for detecting voice call data, the method comprising:
identifying a data stream containing a plurality of data packets;
determining whether the data stream is associated with a single device;
determining whether the data stream is actively communicating data packets;
identifying a data packet size associated with the data packets; and
reserving bandwidth for the data stream if the data stream is associated with a single device, is actively communicating data packets, and the data packet size is smaller than a threshold value.

2. A method as recited in claim 1 wherein the plurality of data packets are voice prioritized data packets.

3. A method as recited in claim 1 wherein the plurality of data packets are WiFi Multimedia voice prioritized IP packets.

4. A method as recited in claim 1 wherein the single device is a local device configured to send or receive the plurality of data packets.

5. A method as recited in claim 1 wherein actively communicating data packets includes communicating at least one data packet every 200 milliseconds.

6. A method as recited in claim 1 wherein actively communicating data packets includes communicating at least one data packet every 200 milliseconds for a previous three consecutive data packets.

7. A method as recited in claim 1 wherein the data packet size threshold value is less than or equal to 450 bytes.

8. A method as recited in claim 1 wherein reserving bandwidth includes assigning a priority level to the data stream that is higher than priority levels associated with non-voice call data streams.

9. A method as recited in claim 1 further comprising determining whether the data stream is associated with an interface port 500.

10. A method as recited in claim 1 further comprising determining whether the data stream is associated with an interface port 4500.

11. A method as recited in claim 1 wherein reserving bandwidth for the data stream includes applying a rate limiting function to the data stream if another voice call is actively using available bandwidth.

12. A method as recited in claim 1 further comprising identifying a start of a voice call if the data stream is associated with a single device, is actively communicating data packets, and the data packet size is smaller than a threshold value.

13. A method as recited in claim 1 further comprising detecting termination of the data stream.

14. A processor-implemented method comprising:
identifying a data stream containing a plurality of voice prioritized data packets;
determining whether the data stream is associated with a single device;
determining whether the data stream is actively communicating voice prioritized data packets;
determining whether the data stream is associated with a specific network interface port;
identifying the data stream as a voice call if the data stream is associated with a single device, is actively communicating voice prioritized data packets, and is associated with the specific network interface port.

15. A method as recited in claim 14 further comprising reserving bandwidth for the data stream if the data stream is associated with a single device, is actively communicating voice prioritized data packets, and is associated with the specific network interface port.

16. A method as recited in claim 14 wherein the plurality of voice prioritized data packets are WiFi Multimedia voice prioritized IP packets.

17. A method as recited in claim 14 further comprising identifying a data packet size associated with the plurality of voice-prioritized data packets.

18. A method as recited in claim 14 wherein the specific network interface port is interface port 500 or 4500.

19. A method as recited in claim 14 wherein actively communicating voice prioritized data packets includes communicating at least one voice prioritized data packet every 200 milliseconds.

20. A data communication apparatus comprising:
a processor; and
a memory coupled to the processor, the memory comprising computer-executable instructions that when executed by the processor performing operations including:
identifying a data stream containing a plurality of data packets;
determining whether the data stream is associated with a single device;
determining whether the data stream is actively communicating data packets;
determining whether the data stream is associated with a specific network interface port;
identifying a data packet size associated with the data packets; and
reserving bandwidth for the data stream if the data stream is associated with a single device, is actively communicating data packets, is associated with the specific network interface port, and the data packet size is smaller than a threshold value.
